(19) United States
(12) Patent Application Publication
(10) Pub. No.: US 2025/0231526 A1
(43) Pub. Date: Jul. 17, 2025

(54) IMAGE FORMING APPARATUS

(71) Applicant: CANON KABUSHIKI KAISHA, Tokyo (JP)

(72) Inventors: FUYUKO KOYAMA, Kanagawa (JP); JUNICHI SEKIYAMA, Tokyo (JP); KENICHI OGAWA, Kanagawa (JP)

(21) Appl. No.: 18/967,395

(22) Filed: Dec. 3, 2024

(30) Foreign Application Priority Data
Jan. 15, 2024 (JP) 2024-003747

(51) Int. Cl. G03G 21/20; G03G 15/00

(52) U.S. Cl. CPC G03G 21/20; G03G 15/80

(57) ABSTRACT

An image forming apparatus includes a metallic plate, a projection member, a hole and a bent portion. The projection member is provided with a projection portion projecting from the metallic plate. The hole is formed by cutting and raising a part of the metallic plate. The bent portion is cut and raised from the hole. The projection portion projects from the hole. The bent portion is positioned below the projection portion in a direction of gravity in a state in which the projection portion projects from the hole, and covers the projection portion as seen from below in the direction of gravity.

### FIELD OF THE INVENTION AND RELATED ART

The present invention relates to an image forming apparatus.

Conventionally, the image forming apparatus such as a copy machine, a printer, a facsimile and a multifunction machine thereof are provided with an electric board to control an actuator for driving the apparatus, such as a motor and a solenoid, and power supply thereto. To the image forming apparatus provided with the electric board, a configuration to prevent spread of fire to other portions of the apparatus in case a fire occurs due to an abnormality in an electrical circuit in the electric board, etc., for example, is employed. For example, in Japanese Patent Application Laid-Open No. 2007-315640, by covering the electric board with a case made of material which has flame retardancy or non-flammability, the spread of fire to other portions in a case in which a fire occurs due to the electric board is prevented.

In the image forming apparatus, in case an element on the electric board, etc. ignites as well, in order to prevent the spread of fire, the following fire spread prevention measure is taken for a resin member within a range in which a distance from a component which may ignite (hereafter referred to as an “ignition source”) is a certain distance or less. For example, the fire spread prevention measure is taken by using material of which the flame retardancy is high for the resin member, or in a case in which the material of which the flame retardancy is high cannot be used for the target resin member, by disposing a fire spread prevention barrier between the ignition source and the resin member. In particular, it is important to provide the fire spread prevention measure to a component of which flame retardancy is low. In the image forming apparatus, many gears for transmitting drive are used. As material for the gear, generally, POM (Polyoxymethylene) is commonly used, and POM generally has low flame retardancy and is often HB material in flame retardant grades, which does not have self-extinguishing property. These gears are often accommodated in a drive box, which is constituted by metallic plates, however, in a case in which a part of the gear is exposed from the metallic plates or in a case in which the gears are provided directly on a side plate of a main assembly and a distance from the ignition source is short, the fire spread prevention measure is necessary.

### SUMMARY OF THE INVENTION

Addition of a fire protection sheet, of which fire retardancy is high, may lead to an increase of cost, and also require a space for the fire protection sheet and a component for holding the fire protection sheet, which results in an increase in size of an apparatus. In addition, even in a case in which components are disposed with sufficient distances from the ignition source, a foreign matter may fall from above the ignition source and cause the fire to spread. Therefore, for areas into which there is a risk of falling of the foreign matter, measures such as providing a shielding member against the ignition source may be considered, however, as in the case of the fire protection sheet described above, there are problems on the cost-up and the space.

The present invention is conceived under such backgrounds and an object of the present invention is, while realizing low cost and space saving, shielding heat from a heat generating source to a resin member and preventing spread of fire caused by ignition or a foreign matter.

In order to solve the aforementioned problems, the present invention includes the following configurations.
(1) An image forming apparatus comprising: a metallic plate; a projection member provided with a projection portion projecting from the metallic plate; a hole formed by cutting and raising a part of the metallic plate; and a bent portion cut and raised from the hole, wherein the projection portion projects from the hole, and wherein the bent portion is positioned below the projection portion in a direction of gravity in a state in which the projection portion projects from the hole, and covers the projection portion as seen from below in the direction of gravity.
(2) An image forming apparatus comprising: a metallic plate; a projection member provided with a projection portion projecting from the metallic plate; and a visor member provided below the projection portion in a direction of gravity, wherein the visor member covers the projection portion as seen from below in the direction of gravity.

Further features of the present invention will become apparent from the following description of exemplary embodiments with reference to the attached drawings.

### BRIEF DESCRIPTION OF THE DRAWINGS

FIG. 1 is a schematic cross-sectional view to describe a configuration of an image forming apparatus in an Embodiment.

FIG. 2, part (a) and part (b), includes perspective views to describe a configuration of a metallic plate in the Embodiment.

FIG. 3 is a schematic cross-sectional view to describe the configuration of the metallic plate in the Embodiment.

FIG. 4, part (a) and part (b), includes schematic cross-sectional views to describe the configuration of the metallic plate in the Embodiment.

FIG. 5, part (a) and part (b), includes a perspective view and a schematic cross-sectional view illustrating the configuration of the metallic plate in the Embodiment.

FIG. 6, part (a), part (b) and part (c), includes perspective views illustrating another configuration of the metallic plate in the Embodiment.

### DESCRIPTION OF THE EMBODIMENTS

Hereinafter, with reference to the drawings, Embodiments of the present invention will be exemplified. However, dimensions, material, shapes and relative dispositions of constituting components described in the Embodiments should be appropriately altered according to configurations of an apparatus, to which the present invention is applied, and various conditions, and are not intended to limit the scope of the present invention to the following Embodiments.

### EMBODIMENT

### Image Forming Apparatus

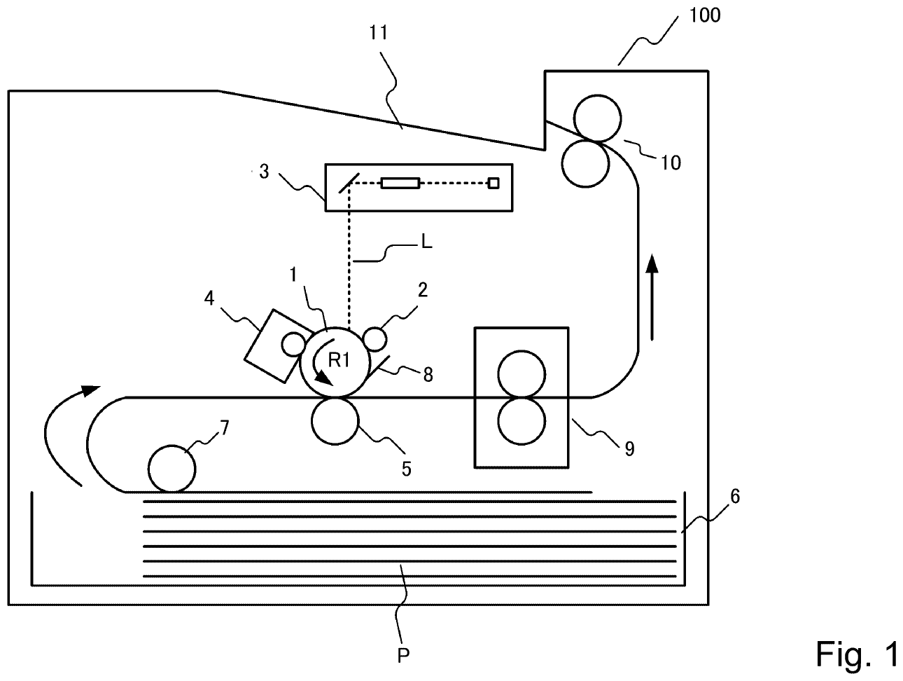

FIG. 1 is a schematic cross-sectional view illustrating a configuration of an image forming apparatus 100 of the present Embodiment. The image forming apparatus 100 is a laser printer using an electrophotographic recording technique, and, hereinafter, operation thereof will be briefly described. When the image forming apparatus 100 receives a print instruction, a scanner unit 3 emits a laser light L corresponding to image information. A photosensitive drum 1, which is charged to a predetermined polarity by a charging roller 2, is scanned by the laser light L, and by this, an electrostatic latent image corresponding to the image information is formed on a surface of the photosensitive drum 1. Thereafter, a developing unit 4 supplies toner to the photosensitive drum 1 to form a toner image corresponding to the image information on the photosensitive drum 1. The toner image, which reaches a transfer position, which is formed by the photosensitive drum 1 and a transfer roller 5, by rotation of the photosensitive drum 1 in a direction of an arrow R1, is transferred to a recording material P fed by a pickup roller 7 from a cassette 6. The surface of the photosensitive drum 1, which has passed through the transfer position, is cleaned by a cleaner 8. The recording material P, on which the toner image is transferred, is subject to heat and pressure by a heating device 9 and a fixing process is applied thereto. Thereafter, the recording material P is discharged by a discharging roller 10 to a tray 11. Incidentally, the image forming apparatus 100 in the present Embodiment is a monochrome image forming apparatus provided with single photosensitive drum 1, however, a number of the photosensitive drums 1 is not limited to one, but the present invention can also be applied to a color image forming apparatus provided with a plurality of the photosensitive drums 1.

### A Motor 20 and an Electric Board

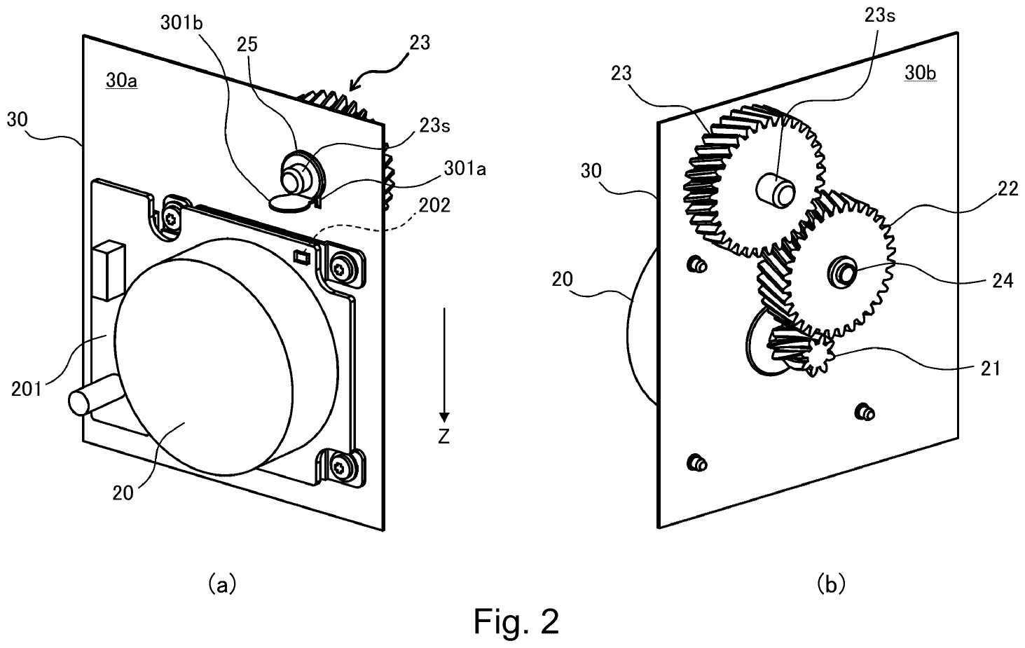

In FIG. 2, an example of an electric board 201, a motor 20 and gears for rotationally driving a plurality of rollers as rotatable members, which are illustrated in FIG. 1, and a metallic plate 30, to which these components are attached, are illustrated. The metallic plate 30 includes a surface 30a, to which the electric board 10 201 is attached, and a surface 30b, which is an opposite side of the surface 30a and to which a gear 23 etc. are attached. Incidentally, the metallic plate 30 may be attached to a frame (side plate of a main assembly), which is provided to the image forming apparatus 100, or the frame itself may be configured to be the metallic plate 30. Part (a) of FIG. 2 is a perspective view of the motor 20 as seen from a front side thereof, and part (b) of FIG. 2 is a perspective view of the motor 20 as seen from a rear side thereof. In part (a) of FIG. 2, a main body of the motor 20 and the electric board 201, which is integrated with the motor 20 and supplies power to the motor 20, are illustrated.

In part (b) of FIG. 2, a motor gear 21, which is attached to a rotation shaft of the motor 20, a gear 22, which meshes with the motor gear 21 and transmits driving force, a metallic shaft 24, which supports the gear 22, and the gear 23, which meshes with the gear 22, are illustrated. In addition, a cut and raised hole 301a, which is opened in the metallic plate 30 in order to attaching a bearing which supports a shaft portion 23s (projection member) of the gear 23, and a cut and raised bent portion 301b are illustrated in part (a) of FIG. 2. Furthermore, a bearing 25, which is attached to the cut and raised hole 301a on the surface 30a side and supports the shaft portion 23s of the gear 23, illustrated in part (a) of FIG. 2. The shaft portion 23s of the gear 23 projects from the cut and raised hole 301a on the surface 30a side. In the present Embodiment, the motor gear 21, the gears 22 and 23 are made of POM from a standpoint of sliding property, and the bearing 25 is made of PC+ABS.

Here, on the electric board 201 illustrated in part (a) of FIG. 2, various electric components are disposed. Some electric components may burn and generate flames, sparks or red heat in a case in which there is an abnormality in an electrical circuit, and hereinafter such an electric component is referred to as an ignition source. Therefore, safety measures are taken to prevent spread of fire to other portions of the apparatus just in case ignition occurs from the ignition source.

A distance out of reach of fire even in the case in which the ignition occurs from the ignition source is referred to as a fire spread prevention distance. For example, it is configured that a resin component is disposed so that a distance from the ignition source to the resin component is the fire spread prevention distance or more, or in a case in which it is inevitable to dispose the resin component within the fire spread prevention distance, it is configured that a flame retardant grade of material thereof is UL94 V-1 or higher. In addition, in a case in which it is inevitable to dispose a component, of which the flame retardant grade is low, within the fire spread prevention distance, measures such as disposing a shielding member, which is another component and made of metal or material, of which the flame retardancy is high, between the ignition source and the target component are taken.

Examples of the element as an example of the ignition source include a transistor, an IC, an LSI, an optical element (an LED, a semiconductor laser, a light receiving element, a multifunctional optical element, etc.), a resistor, a diode, a switch, a relay, a printer head module, a ceramic capacitor, an inductor, a connector, an electric wire, a brush motor, an aluminum electrolytic capacitor, etc. Incidentally, on a back surface of the electric board 201 illustrated in FIG. 2 (the surface opposite to the metallic plate 30 in the electric board 201), a ceramic capacitor 202 is disposed and used as an element which drives the motor 20. In FIG. 2, the ceramic capacitor 202 is indicated by a broken line.

### Cut and Raised Bent Portion

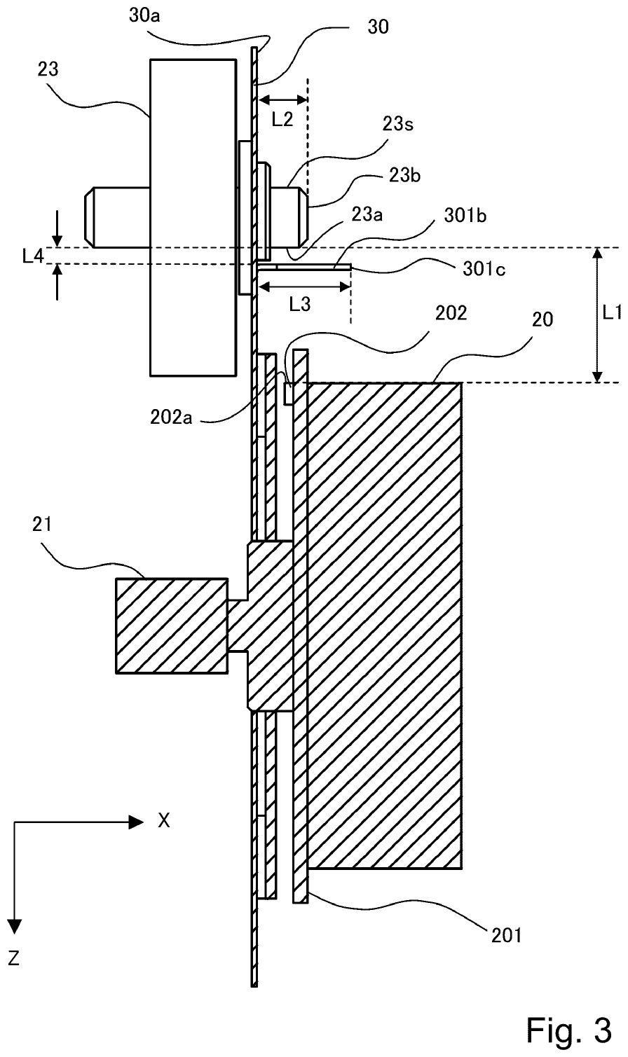

FIG. 3 is a schematic cross-sectional view for illustrating positional relationship between the ceramic capacitor 202 and the gear 23, and a cross-sectional view sectioned by a plane, which goes through a center of the motor 20 and extending in a direction of gravity Z. Since the ceramic capacitor 202 is also the ignition source, for the fire spread prevention, it is preferable, in view of safety, that a component, of which the flame retardant grade is less than V-1, is not disposed within a surrounding range of 40 mm from the ceramic capacitor 202, and that, in a case in which it is inevitable to dispose the component, of which the flame retardant grade is less than V-1 within the surrounding range, the shielding member which prevents the spread of fire is provided.

Here, the direction of gravity Z is defined as down and a direction opposite to the direction of gravity Z is defined as up. In the direction of gravity Z, a distance from an end portion 202a of an upside of the ceramic capacitor 202 to an end portion 23a of a downside of the shaft portion 23s is defined as L1. In the present Embodiment, the shaft portion 23s (projection portion) of the gear 23, which projects from the metallic plate 30, is a POM member, of which the flame retardant grade is HB and which is disposed within the range of 40 mm from the ceramic capacitor 202. That is, the distance L1 is 40 mm at maximum. Therefore, between the ceramic capacitor 202 and the shaft portion 23s of the gear 23, a shielding plate (shielding member) is required to prevent the spread of fire just in case the ceramic capacitor 202 ignites. Conventionally, it is necessary to dispose a separate member which has the flame retardancy. However, in the present Embodiment, it is configured that the cut and raised bent portion 301b is used as the shielding plate to prevent the spread of fire from the ceramic capacitor 202, which is the ignition source.

The bent portion 301b is disposed between the ceramic capacitor 202, which is disposed below the shaft portion 23s, and the shaft portion 23s, and the bent portion 301b as the shielding plate has a shape, which completely covers the shaft portion 23s from the ignition source as seen in the vertical direction (direction of gravity Z). In a normal direction X of the surface 30a, a distance from the surface 30a to an end portion 23b on the surface 30a side of the shaft portion 23s is defined as L2. In addition, in the normal direction X of the surface 30a, a distance from the surface 30a to an end portion 301c of the bent portion 301b (length of the projection) is defined as L3. In the present Embodiment, the bent portion 301b is provided so that the distance L3 is greater than the distance L2 (L3>L2). Furthermore, as seen in the normal direction X of the metallic plate 30, in a direction perpendicular to the direction of gravity Z and the normal direction X, a length (width) of the bent portion 301b is longer than a length (width) of the shaft portion 23s (see part (A) of FIG. 2). By this, as seen from below in the direction of gravity Z, the bent portion 301b covers the shaft portion 23s.

In addition, as an effective disposition of the shielding plate, the following is found from an experiment. That is, in a case in which the ignition source ignites, in order to prevent the spread of fire to the resin shaft, which is disposed above the ignition source, it is found from the experiment that a shielding effect becomes high when the shielding plate covers the resin shaft and the shielding plate is disposed in a vicinity of the resin shaft so that flames do not reach the resin shaft. Therefore, in the present Embodiment, a distance between the shaft portion 23s and the cut and raised bent portion 301b is configured to be 2 mm. Specifically, in the direction of gravity Z, when a distance between the end portion 23a of the downside of the shaft portion 23s and the bent portion 301b is defined as L4, the distance L4 is configured to be 2 mm. Incidentally, as described below, it is preferable that the distance L4 is 3 mm or less.

In a case in which a size of the shielding plate is about the same size as the resin shaft, which is a target to shield, the shielding effect can be expected even if the distance between the shielding plate and the resin shaft is about 10 mm. However, even in a case in which flames and heat are shielded by the shielding plate, since the flames and heat may go around and inside of the shielding plate, i.e., to the resin shaft side, along with rising air current, flames and heat may not be completely shielded. If the size of the shielding plate is sufficiently large with respect to the resin shaft, the shielding effect can be sufficiently expected even if the distance between the shielding plate and the resin shaft is large. However, considering cost and space, a configuration in which the shielding effect is maximized by as small shielding plate as possible is required. Therefore, in the present Embodiment, by completely covering the shaft portion 23s, which is the resin shaft of which the flame retardancy is low, and disposing the cut and raised bent portion 301b, which has approximately the same size as the shaft portion 23s, in an immediate vicinity of and below the shaft portion 23s, effective shielding of the flames and the heat becomes possible without taking a space.

Incidentally, in the present Embodiment, the cut and raised bent portion 301b is configured to have the shape which completely covers the shaft portion 23s, however, it is not necessarily possible to obtain the shielding effect unless the bent portion 301b completely covers the shaft portion 23s. For example, in a case in which the cut and raised bent portion 301b has a small hole of about 2, a slit of about 1 mm, etc., through which the flames cannot penetrate, or in a degree in which an end portion of the bent portion 301b is slightly chipped, it is possible to shield the flames and the heat.

In addition, by using the cut and raised bent, without attaching a new shielding member and incurring costs, it becomes possible to take the fire spread prevention measures. When the bent portion is formed by a cutting and raising process, a hole of the same area as the bent portion is formed. However, in the present Embodiment, by the shaft portion 23s projecting from the cut and raised hole 301a and disposing the cut and raised hole 301a above the cut and raised bent portion 301b as the shielding plate, it is configured that the hole 301a itself is also shielded from the flames and the heat from the ignition source. In the present Embodiment, furthermore, by attaching the bearing 25, which is a V-1 material supporting the shaft portion 23s, to the cut and raised hole 301a, a gap within the hole 301a is filled, which prevents the flames and the heat from spreading through the hole 301a to the opposite side (surface 30b side) of the metallic plate 30.

### Other Reasons for Disposing the Bent Portion in the Vicinity of the Shaft Portion 23s

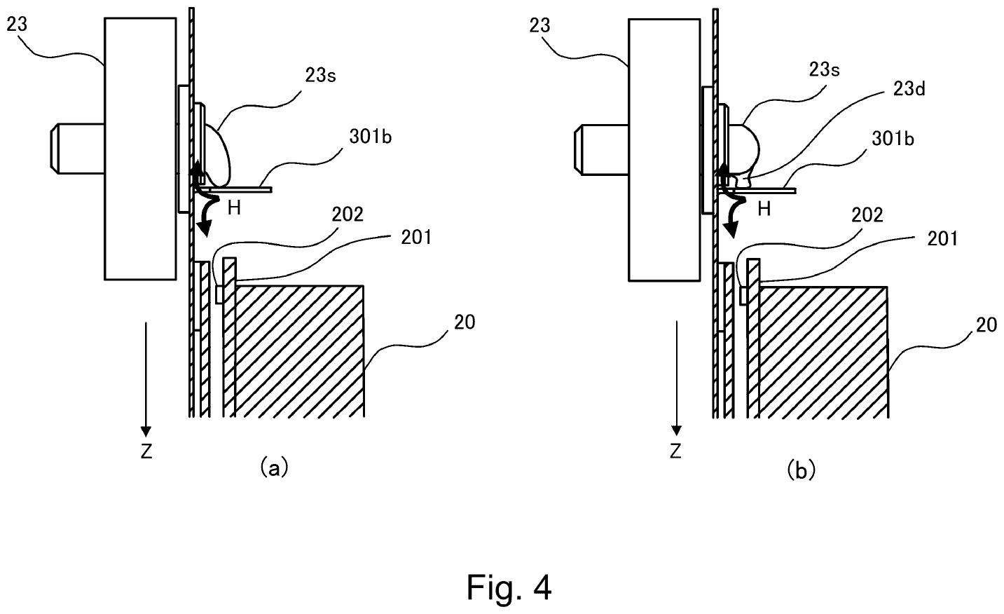

Part (a) of FIG. 4 is a view illustrating a state in which the shaft portion 23s is softened and contacts the bent portion 301b, and part (b) of FIG. 4 is a view illustrating a state in which a part of the shaft portion 23s is melted into a portion 23d of drop shape and contacts the bent portion 301b. The advantages of disposing the cut and raised bent portion 301b and the shaft portion 23s in the vicinity to each other is not limited to the points described above. In the case in which the ignition source should ignite and generate the heat, even if the fire does not spread to the shaft portion 23s and ignite, the resin may be softened and dropped due to the heat, as illustrated in part (a) of FIG. 4 and part (b) of FIG. 4. In such a case, the bent portion 301b can receive the resin which is dropped and deformed from the shaft portion 23s. At this time, by the bent portion 301b being disposed below in the direction of gravity Z and in the vicinity of the shaft portion 23s, it becomes possible to receive the dropped resin securely.

In addition, along with that, by the dropped resin contacting the bend portion 301b, it become possible to release the heat of the dropped resin to the bent portion 301b and the metallic plate 30 (arrow H). Even in a case in which a part of the shaft portion 23s (portion 23d) is completely melted by the heat and the melted resin would drip, if the bent portion 301b is disposed in the vicinity of and below the shaft portion 23s, it becomes possible to receive the dropped resin and release the heat of the resin by the bent portion 301b in the same manner.

At this time, if the dropped resin is completely separated from a main body of the shaft portion 23s, the heat of the main body of the shaft portion 23s cannot be released. Therefore, it is preferable that a clearance (distance L4 described above) between the shaft portion 23s and the bent portion 301b is about 3 mm or less so that the resin (portion 23d), which has the drop shape about to drop, contacts the bent portion 301b before being separated from the shaft portion 23s. In addition, by configuring as such a distance relationship, even in a case in which the fire spreads to the shaft portion 23s, when the drop of the resin occurs in a process of burning of the shaft portion 23s, it becomes possible for the dropped resin to contact the bent portion 301b before being separated from the main body of the shaft portion 23s. And it becomes possible to release the heat of the dropped resin to the bent portion 301b and the metallic plate 30 and quicken an extinguishing of the shaft portion 23s.

### Modified Example 1 of the Bent Portion

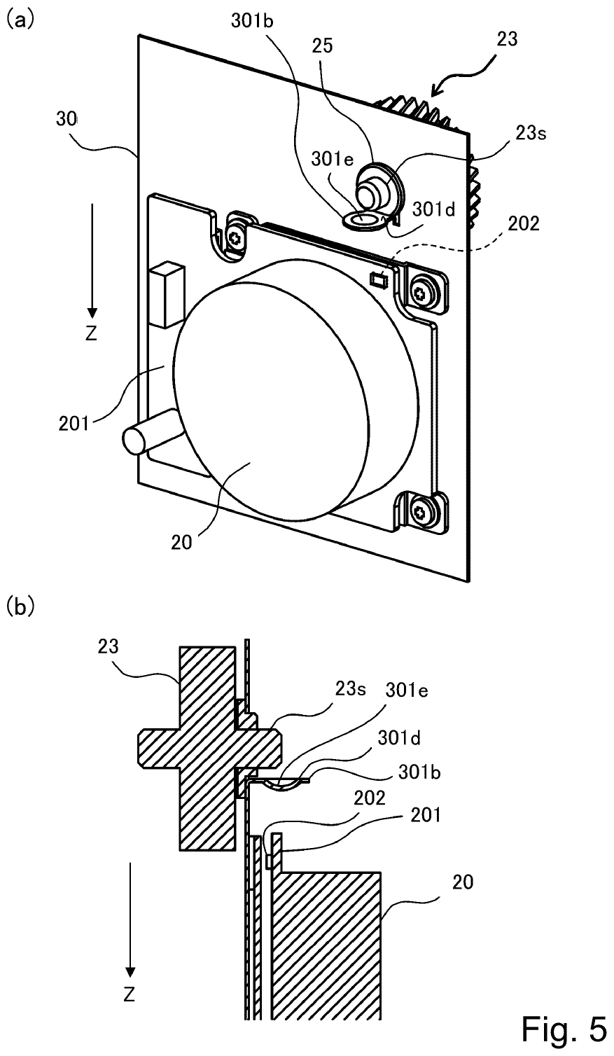

In part (a) of FIG. 5, another example of a shape of the bent portion 301b is illustrated. Part (b) of FIG. 5 is a cross-sectional view sectioned by a vertical plane perpendicular to the metallic plate 30, which goes through a center of the gear 23. In the cut and raised bent portion 301b, on a surface 301d, which is opposing to the shaft portion 23s, a drawing 301e as a concave portion of a concaved shape, which projects below in the direction of gravity Z, is provided. By providing the drawing 301e, in the case in which the resin should drop from the shaft portion 23s, the dropped resin accumulates in the drawing 301e and it becomes not easily for the dropped resin to spill from the bent portion 301b. By this, it becomes possible to reduce risk of which the melted resin drops onto the ignition source and the fire spreads from the dropped resin as a starting point.

In addition, since the shaft portion 23s is a sliding member, there is a possibility that scraped dust, which is generated by the shaft portion 23s being rubbed repeatedly, falls below, or in a case in which lubricating grease is applied to the shaft portion 23s, the lubricating grease drops. As for such a foreign matter, which falls from the shaft portion 23s, in the same manner as the dropped resin described above, it becomes possible for the cut and raised bent portion 301b to receive. In addition, it becomes possible to accumulate the fallen foreign matter in the drawing 301e. By this, it becomes possible to reduce the risk of which the foreign matter falls onto the ignition source and the fire spreads from the fallen foreign matter as a starting point.

In the present Embodiment, the shaft portion 23s is a resin shaft, however, even in a case in which the shaft portion 23s is a metallic shaft, there is a possibility that scraped dust falls by the shaft portion 23s being rubbed, or the lubricating grease drops. Therefore, by applying the present invention to the case of the metallic shaft, it is possible to reduce the risk of which fire spreads from the fallen foreign matter as a starting point.

### Modified Example 2 of the Bent Portion

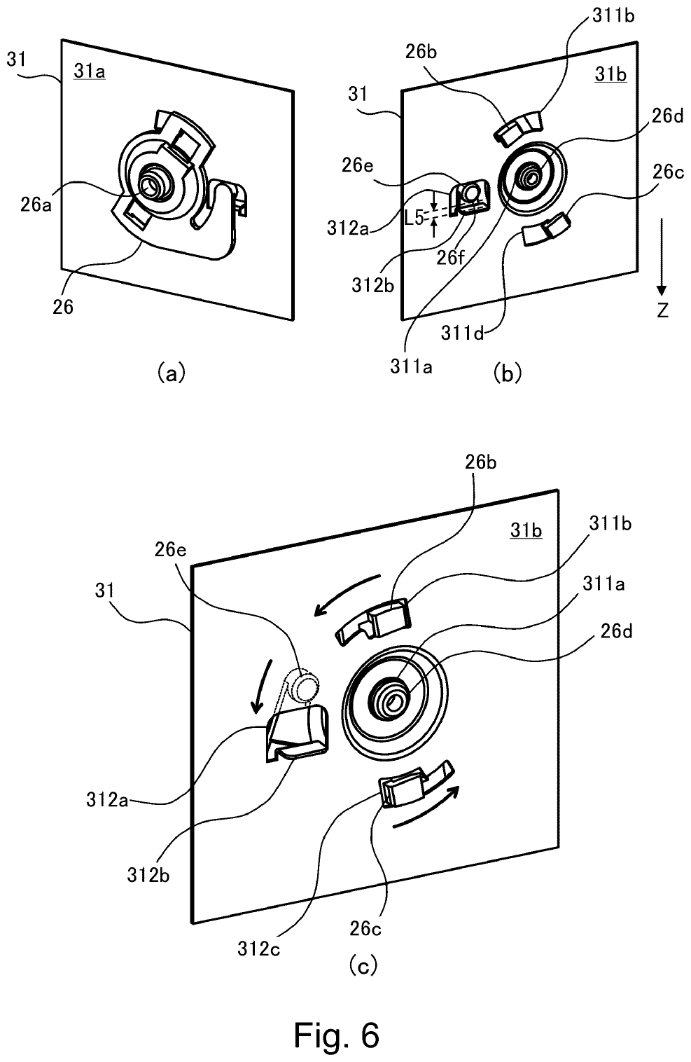

Next, another example, to which the present invention is applied, will be described using FIG. 6. Part (a) and part (b) of FIG. 6 are perspective views illustrating a part of a metallic plate 31 provided in the image forming apparatus 100 and a bearing member 26 (projection member), which holds an unshown shaft attached to the metallic plate 31. Here, the metallic plate 31 includes a surface 31a, to which the bearing member 26 is attached, and a surface 31b, which is an opposite side of the surface 31a and to which an electric board (not shown) is attached. In part (a) of FIG. 6, a state in which the metallic plate 31 is seen from a front side, and in part (b) of FIG. 6, a state in which the metallic plate 31 is seen from a back side are illustrated. In part (c) of FIG. 6, a state in which the bearing member 26 is attached to the metallic plate 31 is illustrated.

The bearing member 26 is a member capable of holding the unshown shaft member in a bearing portion 26a. It is configured that, first, a hook portion 26b is inserted into a hole 311b on the metallic plate 31, a hook portion 26c is inserted into a hole 311c on the metallic plate 31, and a shaft portion 26d is inserted into a burring hole 311a. After that, the shaft portion 26d is attached to the metallic plate 31 while rotated counterclockwise about a center of the burring hole 311a of the metallic plate 31.

A convex portion 26e (projection portion) illustrated in FIG. 6 is a retainer for the bearing member 26, which the bearing member 26 includes, and is configured to fit into a cut and raised hole 312a on the metallic plate 31. Here, since the bearing member 26 is a bearing, the bearing member 26 is made of POM and the flame retardant grade thereof is HB. However, a cut and raised bent portion 312b (visor member) below the cut and raised hole 312a is positioned in an immediate vicinity of and below the convex portion 26e, and is positioned at a position of 2 mm from the convex portion 26e. That is, in the direction of gravity Z, when a distance between an end portion 26f of a downside of the convex portion 26e and the bent portion 312b is defined as L5, the distance L5 is configured to be 2 mm (≤3 mm). Incidentally, the bent portion 312b, similarly to the bent portion 301b, may include a concave portion of concaved shape, which projects below.

The cut and raised bend portion 312b sufficiently covers the convex portion 26e in the vertical direction, and similarly to the cut and raised bent portion 301b (FIG. 2) described above, the cut and raised bend portion 312b functions as the shielding plate. Since the bent portion 312b shields the flames and the heat from the ignition source below, in a case in which the ignition sources is disposed below the convex portion 26e, it becomes possible to reduce the risk of the spread of fire from the ignition source. As illustrated in FIG. 2 and FIG. 6, the cut and raised bend portion may have, as long as a shape of the bent portion covers the resin member as seen from below in the direction of gravity Z, a circular shape, as of the bent portion 301b, a rectangular shape, as of the bent portion 312b, or even different shapes.

Incidentally, in the Embodiment described above, in order to prioritize cost, when a hole, which is provided at a required position, is formed as the cut and raised hole, the portion is cut and raised below in the direction of gravity Z, and the cut and raised bent portion is used as the shielding plate. However, even in a case in which a separate member of the same shape is attached as a shielding plate, the same shielding effect can be obtained. In addition, the cut and raised bent portion may be provided according to positions of elements mounted on the electric board.

Furthermore, in the Embodiments described above, since the shaft portion made of POM is inserted into the cut and raised hole, the cut and raised bent portion is provided below the cut and raised hole, however, it is not limited thereto. In a case in which a member, of which the flame retardant grade is low, is above the cut and raised hole and a heat generating source is below the cut and raised hole, it may be configured to provide the cut and raised bent portion above the cut and raised hole and make the cut and raised bent portion function as the shielding plate for the member above the cut and raised hole.

As described above, according to the Embodiments, while realizing low cost and space saving, it becomes possible to shield the heat from the heat generating source to the resin member and prevent the spread of fire caused by the ignition or the foreign matter.

The disclosure of the present embodiments includes the following constitution examples.

### Constitution 1

An image forming apparatus comprising:
a metallic plate;
a projection member provided with a projection portion projecting from the metallic plate;
a hole formed by cutting and raising a part of the metallic plate; and a bent portion cut and raised from the hole,
wherein the projection portion projects from the hole, and
wherein the bent portion is positioned below the projection portion in a direction of gravity in a state in which the projection portion projects from the hole, and covers the projection portion as seen from below in the direction of gravity.

### Constitution 2

The image forming apparatus according to Constitution 1, wherein the bent portion is provided with a concave portion of which a surface is opposite to the projecting portion is projected downward.

### Constitution 3

The image forming apparatus according to Constitution 1, wherein the projection member is a sliding member.

### Constitution 4

The image forming apparatus according to Constitution 1, wherein in the direction of gravity a distance between a lower end portion of the projection portion and a surface, of the bent portion, opposite to the projecting portion is 3 mm or less.

### Constitution 5

An image forming apparatus according to Constitution 1, further comprising a rotatable member:
a motor configured to drive the rotatable member;
a gear provided with a shaft portion and configured to transmit drive of the motor to the rotatable member;
an electric board to which the motor is attached; and
an element mounted on the electric board,
wherein the electric board is attached to the metallic plate,
   wherein the projection portion is the shaft portion of the gear, and
wherein the element is positioned below the bent portion in the direction of gravity.

### Constitution 6

An image forming apparatus comprising:
a metallic plate;
a projection member provided with a projection portion projecting from the metallic plate; and
a visor member provided below the projection portion in a direction of gravity,
wherein the visor member covers the projection portion as seen from below in the direction of gravity.

### Constitution 7

The image forming apparatus according to Constitution 6, wherein the visor member is provided with a concave portion of which a surface is opposite to the projecting portion is projected downward.

### Constitution 8

The image forming apparatus according to Constitution 6, wherein in the direction of gravity a distance between a lower end portion of the projection portion and the visor member opposite to the projecting portion is 3 mm or less.

### Constitution 9

The image forming apparatus according to Constitution 6, further comprising a shaft member:
a bearing member provided with a convex portion and to which the shaft member is attached;
an electric board attached to the metallic plate; and
an element mounted on the electric board,
wherein the bearing member is attached to the metallic plate,
   wherein the projection portion is the convex portion of the bearing member, and
wherein the element is positioned below the visor member in the direction of gravity.

### Constitution 10

The image forming apparatus according to Constitution 1, wherein the projection member is a resin member.

According to the present invention, while realizing low cost and space saving, it becomes possible to shield the heat from the heat generating source to the resin member and prevent the spread of fire caused by the ignition or the foreign matter.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No.2024-003747, filed on Jan. 15, 2024 which is hereby incorporated by reference herein in its entirety.

What is claimed is:

1. An image forming apparatus comprising:
a metallic plate;
a projection member provided with a projection portion projecting from the metallic plate;
a hole formed by cutting and raising a part of the metallic plate; and
a bent portion cut and raised from the hole,
wherein the projection portion projects from the hole, and
wherein the bent portion is positioned below the projection portion in a direction of gravity in a state in which the projection portion projects from the hole, and covers the projection portion as seen from below in the direction of gravity.

2. The image forming apparatus according to claim 1, wherein the bent portion is provided with a concave portion of which a surface is opposite to the projecting portion is projected downward.

3. The image forming apparatus according to claim 1, wherein the projection member is a sliding member.

4. The image forming apparatus according to claim 1, wherein in the direction of gravity a distance between a lower end portion of the projection portion and a surface, of the bent portion, opposite to the projecting portion is 3 mm or less.

5. An image forming apparatus according to claim 1, further comprising
a rotatable member:
a motor configured to drive the rotatable member;
a gear provided with a shaft portion and configured to transmit drive of the motor to the rotatable member;
an electric board to which the motor is attached; and
an element mounted on the electric board,
wherein the electric board is attached to the metallic plate,
wherein the projection portion is the shaft portion of the gear, and
wherein the element is positioned below the bent portion in the direction of gravity.

6. An image forming apparatus comprising:
a metallic plate;
a projection member provided with a projection portion projecting from the metallic plate; and
a visor member provided below the projection portion in a direction of gravity,
wherein the visor member covers the projection portion as seen from below in the direction of gravity.

7. The image forming apparatus according to claim 6, wherein the visor member is provided with a concave portion of which a surface is opposite to the projecting portion is projected downward.

8. The image forming apparatus according to claim 6, wherein in the direction of gravity a distance between a lower end portion of the projection portion and the visor member opposite to the projecting portion is 3 mm or less.

9. The image forming apparatus according to claim 6, further comprising
a shaft member:
a bearing member provided with a convex portion and to which the shaft member is attached;
an electric board attached to the metallic plate; and
an element mounted on the electric board,
wherein the bearing member is attached to the metallic plate,
wherein the projection portion is the convex portion of the bearing member, and
wherein the element is positioned below the visor member in the direction of gravity.

10. The image forming apparatus according to claim 1, wherein the projection member is a resin member.
